(19) United States
(12) Patent Application Publication
(10) Pub. No.: US 2014/0216606 A1
(43) Pub. Date: Aug. 7, 2014

(54) Non-oriented Electrical Steel Strip Having Excellent Magnetic Properties and Production Method Thereof

(71) Applicants: Yoon-Jung Heo, Suji-gu, Yongin-si, Gyeonggi-do (KR); Nam-Hoe Heo, Pohang-si, Gyeongsangbuk-do (KR); Kyoung-Soon Park, Pohang-si, Gyeongsangbuk-do (KR); Dong-Hoe Heo, Nam-gu, Incheon (KR); Sun-Mi Kwoun, Buk-gu, Pohang-si, Gyeongsangbuk (KR); Hyuk-Ki Kwoun, Yongsan-gu, Seoul (KR)

(72) Inventor: Nam-Hoe Heo, Gyeongsangbuk-do (KR)

(73) Assignee: Nam-Hoe Heo, Pohang-si, Gyeongsangbuk-do (KR)

(21) Appl. No.: 13/991,582

(22) PCT Filed: Jan. 17, 2013
(86) PCT No.: PCT/KR2013/000359

§ 371 Date: Jun. 4, 2013

(30) Foreign Application Priority Data
Mar. 27, 2012 (KR) 10-2012-0031294

(51) Int. Cl. H01F 1/16; H01F 1/147; C21D 8/02

(52) U.S. Cl. CPC H01F 1/16; C21D 8/0263; H01F 1/14791
USPC 148/111; 148/307

(57) ABSTRACT

The present invention relates to a non-oriented electrical steel strip, which is used as a core for electrical devices such as motors and transformers, and a production method thereof. In accordance with one embodiment of the invention, there is provided a method for producing a (100) [0vw] non-oriented electrical steel strip having excellent magnetic properties, in which a slab having a composition comprising 0.0001-0.035 wt % of S and the balance of Fe and inevitable impurities, thereby showing a ferrite structure throughout the entire temperature range, is hot-rolled, pickled and cold-rolled, and the cold-rolled steel strip is annealed so that the selective growth of (100) grains on the surface of the cold-rolled steel strip occurs and the surface of the annealed steel strip is composed of the (100) [0vw] orientation.

### TECHNICAL FIELD

The present invention relates to a non-oriented electrical steel strip, which is used as a core for electrical devices such as motors and transformers, and a production method thereof, and more particularly to a (100) [0vw] non-oriented electrical steel strip having excellent magnetic properties and a production method thereof.

### BACKGROUND ART

In recent years, the use of electrical devices in high-frequency regions has increased for the purpose of high efficiency and miniaturization. Particularly, in the case of power generators for electric vehicles, an improvement of magnetic properties in a high-frequency region of 400-1,000 Hz. has been strongly required.

Non-oriented electrical steel strips are important parts required for converting electrical energy into mechanical energy in electrical devices, and the magnetic properties thereof need to be improved. In other words, it is necessary to lower the core loss and increase the magnetic flux density.

Core loss is the amount of energy lost as heat during energy conversion, and magnetic flux density is expressed as a force that generates power. Thus, when the magnetic flux density of steel strips is high, the core loss of electrical devices can be reduced, making it possible to reduce the size of the electrical devices.

Although the core loss of a steel strip can be lowered by reducing the thickness of the steel strip or increasing the amount of alloying elements added, clean steel having a low impurity content has been produced, and steel having improved magnetic properties as a result of the addition of additional elements has been produced. In the case of the former, the production cost of the steel is increased due to additional processes, and in the case of the latter, the additional elements increase the production cost of the steel.

In a current general method for producing a high-grade (111) [uvw] non-oriented electrical steel strip, the steel strip comprises about 3 wt % Si as a main alloy, 0.5-1.4 wt % Al, 0.1-0.4 wt % Mn and the balance of iron and inevitable impurities, and the desirable magnetic properties of the steel strip are obtained by reducing the slab heating temperature in a hot rolling process. Specifically, when the slab heating temperature is as low as 1050 to 1150° C., the steel strip can have good magnetic properties. This is because it is the only method to reheat the slab at a low temperature in order to prevent the generation of fine AlN or MnS, which interferes with grain growth in a final annealing process which is performed by a winding-rewinding method.

Specifically, AlN and MnS precipitate as coarse particles during the solidification of molten steel and are dissolved again during the heating of the slab, and the dissolved [Al], [N], [Mn] and [S] re-precipitate to form AlN and MnS at the end of hot rolling. For this reason, as the slab reheating temperature increases, the amount of [Al], [N], [Mn] and [S], which result from dissolution, increases and thus interferes with grain growth in the final annealing process. Thus, the slab reheating temperature should be low in order to obtain good magnetic properties, and in this case, the finish rolling temperature is also naturally low, generally 850° C.

When considering the alloy design theory, in growth grain occurring in a 3% silicon steel strip, a (110) [001] Goss texture is not a final texture which is obtained in the 3% silicon steel strip. Even in the same 3% silicon steel strip, depending on a combination of the cold rolling ratio, the heat treatment atmosphere, the heating rate and the like, the surface segregation concentration of S varies and the surface energy of surface grains in each crystallographic orientation varies. Thus, it can be concluded that the above-described various determined parameters that are applied in a 3% silicon electrical steel strip production line are merely a specific combination, which lowers the surface segregation concentration of S to minimize the surface energy of (110) [001] surface grains and facilitates the surface-energy-induced selective growth of the grains to allow only the (110) [001] surface grains to remain. As used herein, the term “segregation” refers to a phenomenon in which the free atom S contained in an electrical steel strip gathers on the surface or the grain boundary in the form of free atoms during final annealing.

FIG. 1 shows ideal crystallographic orientations and the crystallographic orientations measured by the Etch-pit method, and FIG. 2 is a schematic view illustrating the segregation phenomena described by N. H. Heo (see non-patent documents 1 and 2).

As shown in the first figure of FIG. 2, the equilibrium segregation concentration (Cs) decreases with increasing temperature, and the segregation concentration at each temperature increases with an increases in the content of S in an electrical steel strip. As shown in the second figure of FIG. 2, when the equilibrium segregation concentration at T₀ is Cs₀ and isothermal heat treatment is performed at T₀, the concentration (I) generally increases toward Cs₀ over time.

However, in a heat-treatment atmosphere containing hydrogen (H), the loss of surface-segregated S occurs due to an H₂S reaction between surface-segregated S and hydrogen, and for this reason, the segregation concentration (II) on the surface continues to decrease with time after any maximum point P.

Meanwhile, in the case in which electrical steel strips having the same component are isothermally heat-treated at the same temperature, if the isothermal heat treatment is performed at T₀ as shown in the third figure of FIG. 2, the segregation concentration curve at T₀ will shift from II to III toward a shorter time, as the rate of heating to that temperature increases.

Meanwhile, according to the disclosure of J. Friedel (see non-patent document 3), the surface energy of a body-centered cubic metal is the lowest in (110), intermediate in (100), and the highest in (111).

In addition, with respect to the surface energy of a body-centered cubic metal, when the concentration of surface-segregated S during final annealing is very low, the surface energy of (110) is the lowest. However, as the concentration of surface-segregated S increases, the surface energy of (100) becomes the lowest, and as the concentration of surface-segregated S further increases, the surface energy of (111) becomes the lowest. Thus, only grains having the lowest surface energy grow depending on the concentration of surface-segregated S.

The first to third figures of FIG. 3 shows the change in surface energy as a function of the concentration of surface-segregated S in a body-centered cubic metal, and the fourth figure of FIG. 3 is a schematic view illustrating the surface-energy-induced selective growth suggested by the present inventor (N. H. Heo) (see non-patent document 1). Specifically, in a time zone showing a concentration equal to or lower than the surface segregation concentration C₍₁₁₀₎ of S, the surface-energy-induced selective growth of (110) grains occur while encroaching on (100) and (111) grains, and in a time zone showing a surface segregation concentration equal to or higher than C₍₁₁₁₎, the growth of only (111) grains occurs. In a time zone showing a surface segregation concentration between C₍₁₁₀₎ and C₍₁₁₁₎, the growth of only (100) grains occurs.

Moreover, the present inventor completed the theory of recrystallization nucleation in a modified metal (see non-patent documents 4 and 5). Specifically, based on the theory of elasticity, the present inventor theorized that the crystallographic orientation produced from a modified metal is similar to the crystallographic orientation of a modified parent phase. In addition, this theory was experimentally demonstrated using 3% silicon steel.

FIG. 4 shows the orientation distribution function of a general cold-rolled strip obtained from a pickled hot-rolled strip. In the orientation distribution function, a portion having dense contour lines indicates that a crystallographic orientation showing the portion is strongly formed in the cold-rolled steel strip. Thus, it can be seen that the crystallographic orientation of the cold-rolled steel strip consists of a main crystallographic orientation of (111) [uvw], which is represented by (111) [112] and (111) [110], and a minor crystallographic orientation of (100) [0vw], which is represented by (100) [012].

Meanwhile, studies on the development of (100) [0vw] non-oriented electrical steel strips having excellent magnetic properties compared to conventional (111) [uvw] non-oriented electrical steel strips have been reported. T. Tomida (see non-patent documents 6 and 7) and Korean Patent No. 10-0797895 (patent document 1) describe S as an inevitable impurity, and disclose a method of obtaining a crystallographic orientation of (100) [0vw] with the phase transformation from austenite (γ) to ferrite (α) by a decarburization reaction during the isothermal heat treatment of a steel strip containing a large amount of C in a vacuum, and a method of obtaining a crystallographic orientation of (100) [0vw] using the phase transformation from austenite (γ) to ferrite (α) during high-temperature cooling of a steel strip containing a large amount of Mn.

However, the above-described methods for producing the (100) [0vw] non-oriented electrical steel strips were not commercialized, because a difficult vacuum heat-treatment process is required and the heat-treatment time is as long as several tens of hours.
Patent document 1: Korean Patent Registration No. 10-0797895 (2008.01.18).
Non-patent document 1: Acta Materialia vol. 48, 2000, pp 2901.
Non-patent document 2: Acta Materialia vol. 51, 2003, pp 4953.

Non-patent document 3: Acta metall. vol. 1, 1953, pp 79.
Non-patent document 4: Journal of the Korean Physical Society vol. 44, 2004, pp 1547.
   Non-patent document 5: Materials Letters vol. 59, 2005, pp 2827.
Non-patent document 6: IEEE Trans. Magnetics vol. 37, 2001, pp 2318.
Non-patent document 7: J. Magnetism and Magnetic Materials vol. 254-255, 2003, pp 315.

### DISCLOSURE

### Technical Problem

The present invention has been made in order to solve the above-described problems occurring in the prior art and aims at suggesting a method capable of producing a (100) [0vw] non-oriented electrical steel strip by adding S as the most important element during the production of the steel strip and heat-treating, for a short time, a steel strip having a composition that shows a ferrite structure throughout the entire temperature range of the production process.

In other words, it is a main object of the present invention to provide a (100) [0vw] non-oriented electrical steel strip having excellent magnetic properties and a production method thereof, in which the (100) [0vw] non-oriented electrical steel strip suitable as a core for rotators can be easily produced in a cost- and time-effective manner using a winding-rewinding method by applying the theory of nucleation and the surface-energy-induced selective growth method in final annealing, and annealing a cold-rolled steel strip for a short time in a reducing gas atmosphere in place of a vacuum atmosphere so as to be able to obtain a crystallographic orientation of (100) [0vw].

### Technical Solution

In accordance with one embodiment of the present invention, there is provided a method for producing a (100) [0vw] non-oriented electrical steel strip having excellent magnetic properties, the method comprising: hot-rolling a slab having a composition comprising, by wt %, C: more than 0%, but not more than 0.005%, Si: 2-4%, Mn: not less than 0.05%, but less than 1.0%, S: 0.0001-0.035%, Al: more than 0%, but not more than 0.20%, P: more than 0%, but not more than 0.2%, N: more than 0%, but not more than 0.003%, the balance being Fe and inevitable impurities; pickling the hot-rolled steel strip; cold-rolling the pickled steel strip; subjecting the cold-rolled steel strip to first-stage annealing in a first-stage annealing furnace at temperature of 800° C.˜1100° C.; and subjecting the cold-rolled steel strip to second-stage annealing in a second-stage annealing furnace at a temperature of 1150° C.˜1370° C., which is higher than the temperature of the first-stage annealing furnace, wherein the average grain size (y) and strip thickness (x) of the finally annealed steel strip satisfy the following relationship: y≧2.2x+0.1 (unit: mm) if the content of S is less than 0.007 wt %, and y≧1.48x+0.04 (unit: mm) if the content of S is 0.007 wt % or more.

Preferably, the time of heat treatment in the first-stage annealing furnace is 10-600 seconds, and the time of heat treatment in the second-stage annealing furnace is 10-600 seconds.

Moreover, the hot-rolled steel strip may be subjected to intermediate annealing at a temperature of 950° C.˜1370° C. after the hot rolling in order to dissolve MnS, which can be produced during the hot rolling, to form a solid solution.

Further, the content of S in the composition is more than 0.008%, but not more than 0.035%.

Furthermore, the slab structure during the hot rolling and the annealed strip structure at the annealing temperature are preferably a ferrite phase structure.

In addition, the first-stage and second-stage annealing furnaces preferably employ a reducing gas atmosphere in order to prevent (111) grains from growing due to surface oxidation during the annealing of the cold-rolled steel strip.

In accordance with another embodiment of the present invention, there is provided a (100) [0vw] non-oriented electrical steel strip having excellent magnetic properties, wherein the electrical steel strip has a composition comprising, by wt %, C: more than 0%, but not more than 0.005%, Si: 2-4%, Mn: not less than 0.05%, but less than 1.0%, S: 0.0001-0.035%, Al: more than 0%, but not more than 0.20%, P: more than 0%, but not more than 0.2%, N: more than 0%, but not more than 0.003%, the balance being Fe and inevitable impurities, and the average grain size of the surface of the steel strip is equal to or greater than the thickness of the steel strip.

Herein, the average grain size (y) and strip thickness (x) of the finally annealed steel strip satisfy the following relationship: y≧2.2x+0.1 (unit: mm) if the content of S is less than 0.007 wt %, and y≧1.48x+0.04 (unit: mm) if the content of S is 0.007 wt % or more.

Preferably, the steel strip is subjected to first-stage annealing in a first-stage annealing furnace at a temperature of 800° C.˜1100° C., and subjected to second-stage annealing in a second-stage annealing furnace at a temperature of 1150° C.˜1370° C., which is higher than the temperature of the first-stage annealing furnace, and the time of heat treatment in each of the annealing furnaces is 10-600 seconds.

In addition, the content of S in the composition is more than 0.008%, but not more than 0.035%.

### DESCRIPTION OF DRAWINGS

FIG. 1 shows ideal crystallographic orientations and the crystallographic orientation measured by the Etch-pit method.

FIG. 2 is a schematic view showing a segregation phenomenon.

FIG. 3 is a graphic diagram showing the change in surface energy as a function of the concentration of surface-segregated S in a body-centered cubic metal.

FIG. 4 is a contour diagram showing the orientation distribution function (ODF) of a general cold-rolled steel strip obtained from a pickled hot-rolled steel strip.

FIG. 5 is a graphic diagram showing the orientation distribution of steel type A according to Example 1.

FIG. 6 is a graphic diagram showing the orientation distribution of steel type A according to Example 2.

FIG. 7 is a graphic diagram showing the orientation distribution of steel type A according to Example 3.

FIG. 8 is a graphic diagram showing the Etch-pit structure of steel type A according to Example 3.

FIG. 9 is a graphic diagram showing the orientation distribution of steel type A according to Example 4.

FIG. 10 is a graphic diagram showing the orientation distribution of steel type A according to Example 5.

FIG. 11 is a graphic diagram showing the orientation distribution of steel type A according to Example 6.

FIG. 12 is a graphic diagram showing the orientation distribution of steel type A according to Example 7.

FIG. 13 is a graphic diagram showing the orientation distribution of steel type B according to Example 8.

FIG. 14 is a graphic diagram showing the orientation distribution of steel type C according to Example 9.

FIG. 15 is a graphic diagram showing the orientation distribution of steel type D according to Example 10.

FIG. 16 is a graphic diagram showing the orientation distribution of steel type E according to Example 10.

FIG. 17 is a graphic diagram showing the relationship between the average grain size (y) of the annealed strip surface of steel type A and the strip thickness (x) according to Example 11.

FIGS. 18 and 19 are graphic diagrams showing the orientation distribution of steel type A according to Example 12.

FIG. 20 is a graphic diagram showing the orientation distribution of steel type F according to Example 13.

FIG. 21 is a graphic diagram showing the orientation distribution of steel type A according to Example 14.

FIG. 22 is a graphic diagram showing the orientation distribution of steel type A according to Example 15.

FIG. 23 is a graphic diagram showing the orientation distribution of steel type A according to Example 16.

FIG. 24 is a graphic diagram showing the orientation distribution of steel type G according to Example 17.

FIG. 25 is a graphic diagram showing the orientation distribution of steel type H according to Example 18.

FIG. 26 is a graphic diagram showing the orientation distribution of steel type H according to Example 18.

FIG. 27 is a graphic diagram showing the relationship between the average grain size (y) of the annealed strip surface of steel type H and the strip thickness (x) according to Example 19.

FIG. 28 is a graphic diagram showing the orientation distribution and average grain size (y) of steel type H according to Example 20.

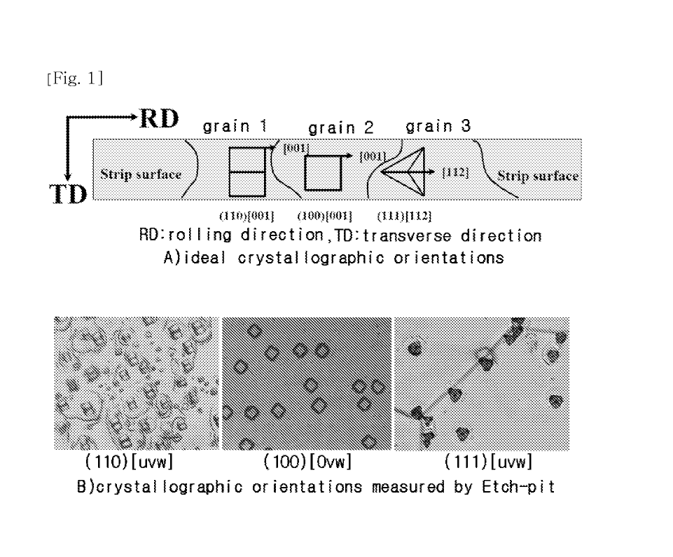

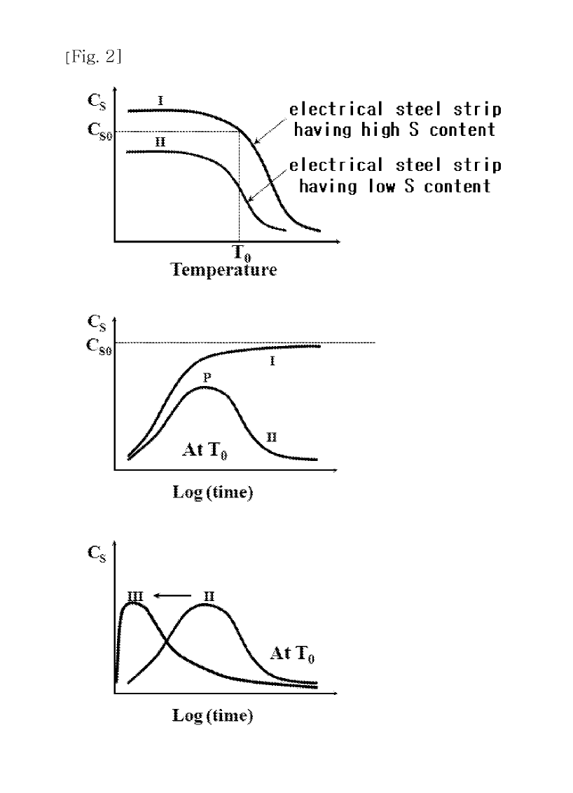

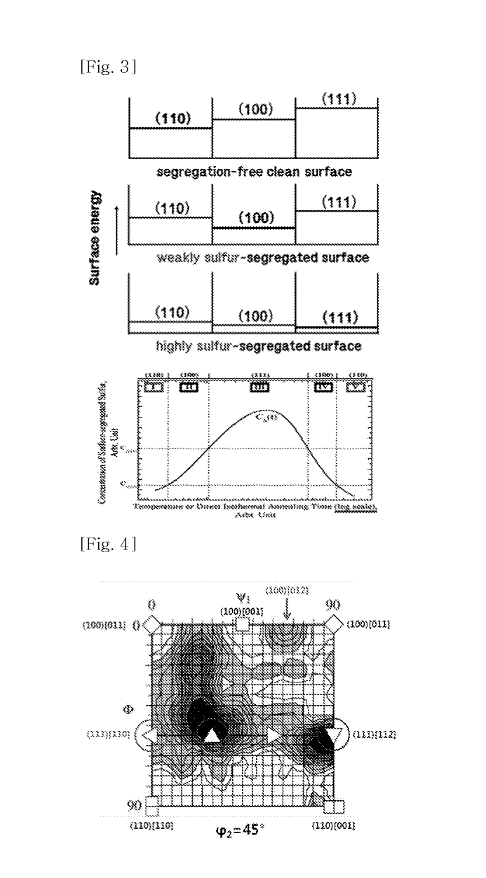

### BEST MODE

Hereinafter, preferred embodiments of the inventive (100) [0vw] non-oriented electrical steel strip having excellent magnetic properties and the production method thereof will be described with reference to the accompanying drawings. In the drawings, the thickness of lines or the size of constituent elements may be exaggerated for the clear understanding and convenience of description.

Also, the terms used in the following description are terms defined taking into consideration the functions obtained in accordance with the present invention, and may be changed in accordance with the option of a user or operator or usual practice. Accordingly, these terms should be defined based on the overall disclosure of de specification.

In addition, the following embodiments are not intended to limit the scope of the present invention, but merely illustrate the constituent elements described in the appended claims, and embodiments, which are included in the technical spirit of the present invention and include equivalents to the constituent elements described in the appended claims, may fall within the scope of the present invention.

In Al deoxidized steel, AlN can be re-dissolved into a solid solution in a steel strip having the composition described below at a slab reheating temperature of 1200° C. or higher, when determined based on the AlN solubility curve suggested by W. C. Leslie et al. (Trans. ASM vol. 46, 1954, pp 1470). Also, in 3% Si steel, MnS can be re-dissolved into a solid solution in a steel strip having the composition described below at a slab reheating temperature of 1,320° C. or higher, when determined based on the MnS solubility curves suggested by N. G. Ainslie (JISI vol. 3, 1960, pp 341) and N. H. Heo (ISIJ International vol. 51, 2011, pp 280).

In order to produce a novel (100) [0vw] non-oriented electrical steel strip according to the present invention, the most important element, S, is added in an amount of 0.0001%-0.035%. Also, on the premise that the main elements Si and Mn of iron-based alloys become a ferrite phase in the entire temperature range during the production process, Al, which interferes with the surface-energy-induced selective growth of (100) grains by surface-segregated S, is inhibited to more than 0 wt %, but not more than 0.20 wt %, N is inhibited to more than 0 wt o, but not more than 0.0030 wt o, and P is inhibited to more than 0 wt %, but not more than 0.2 wt % %, so that MnS can be re-dissolved into a solid solution in the composition range described below when reheating a hot-rolled steel strip at a temperature of 1370° C. or higher.

Thus, in order to maintain a ferrite phase throughout the entire temperature range of the production process, a slab that is used in the present invention has a composition comprising, by wt %, C: more than 0%, but not more than 0.005%, Si: 2-4%, Mn: not less than 0.05%, but less than 1.0%, S: 0.0001-0.035%, Al: more than 0%, but not more than 0.20%, P: more than 0%, but not more than 0.2%, N: more than 0%, but not more than 0.003%, the balance being Fe and inevitable impurities. As a result, a 0.10-0.70 mm thick, (100) [0vw] non-oriented electrical steel strip having excellent magnetic properties can be produced in an easy and cost-effective manner. Among the alloying elements that are added in the present invention, Si shows the greatest increase in resistivity, and the effect of Mn on the increase in resistivity is about half that of Si.

In one embodiment of the present invention, a steel strip is produced by hot-rolling a slab having a composition that comprises, by wt o, C: more than 0%, but not more than 0.005%, Si: 2-4%, Mn: not less than 0.05%, but less than 1.0%, S: 0.0001-0.035%, Al: more than 0%, but not more than 0.20%, P: more than 0%, but not more than 0.2%, N: more than 0%, but not more than 0.003%, the balance being Fe and inevitable impurities, and consists of a ferrite phase throughout the entire temperature range, pickling the hot-rolled strip, cold-rolling the pickled strip, and finally annealing the pickled strip in a reducing gas atmosphere in order to prevent (111) grains from growing due to the surface oxidation of Al, Fe, Si and the like, so that the surface of the annealed strip consists of the (100) [0vw] orientation.

Also, in one embodiment of the present invention, the finally annealed steel strip has a composition that comprises, by wt %, C: more than 0%, but not more than 0.005%, Si: 2-4%, Mn: not less than 0.05%, but less than 1.0%, S: 0.0001-0.035%, Al: more than 0%, but not more than 0.20%, P: more than 0%, but not more than 0.2%, N: more than 0%, but not more than 0.003%, the balance being Fe and inevitable impurities, and consists of a ferrite phase throughout the entire temperature range, the orientation in the finally annealed steel strip is (100) [0vw], and the average grain size (y, mm) and strip thickness (x, mm) of the steel strip satisfy y≧2.2x+0.1.

In addition, in one embodiment of the present invention, a (100) [0vw] non-oriented electrical steel strip is produced by reheating a slab having a composition that comprises by wt %, C: more than 0%, but not more than 0.005%, Si: 2-4%, Mn: not less than 0.05%, but less than 1.0%, S: 0.0001-0.035%, Al: more than 0%, but not more than 0.20%, P: more than 0%, but not more than 0.2%, N: more than 0%, but not more than 0.003%, the balance being Fe and inevitable impurities, and consists of a ferrite phase in the entire temperature range, hot-rolling the reheated slab, optionally subjecting the hot-rolled steel strip to intermediate annealing at 950° C.˜1370° C. in order to dissolve MnS which can be produced during the hot rolling, pickling the hot-rolled strip, cold-rolling the pickled strip, and finally annealing the pickled steel strip in an annealing furnace including a first-stage annealing furnace and a second-stage annealing furnace.

In addition, in one embodiment of the present invention, the heat treatment atmosphere in the first-stage and second-stage annealing furnace is a reducing gas atmosphere in order to prevent (111) grains from growing due to the surface oxidation of Al, Fe, Si and the like. In order to minimize the growth of (111) grains in first-stage annealing and maximize the growth of (100) grains at the second-stage annealing temperature, which is higher than the first-stage annealing temperature, the temperature of the first-stage annealing furnace is 800° C.˜1,100° C., and the temperature of the second-stage annealing furnace is 1,150° C.˜1,370° C., which is higher than the first-stage annealing temperature.

Hereinafter, the reasons why the components and contents of the slab composition according to the present invention are limited will be described.

S: 0.0001-0.035 wt %

As described above, when a suitable amount of surface-segregated S is present, the surface-energy-induced selective growth of desired (100) [0vw] grains can occur. Thus, if the desired S content is eliminated, the surface energy of (110) grains during heat treatment will be the lowest, and only (110) grains will grow while encroaching upon other grains. Thus, in this case, the (110) [uvw] orientation, rather than the (100) [0vw], will be ultimately obtained.

Thus, the substantial S content should be at least 0.0001 wt % so that S can be surface-segregated to change the surface energy. Also, in order to prevent the production of MnS, which interferes with the surface-energy-induced selective growth of (100) [0vw] grains during final annealing, the content of S is preferably limited to 0.035 wt % or less, if possible.

More preferably, the content of S is limited to more than 0.008 wt %, but not more than 0.035 wt %, in view of economic efficiency in current steel making processes.

C: More than 0 Wt %, but not More than 0.005% Wt %

In a conventional method of forming the (100) [0vw] orientation using the austenite (γ)-to-ferrite (α) phase transformation caused by a decarburization reaction that occurs during vacuum heat treatment for a long period, a steel strip essentially comprises 0.02-0.07 wt % of C.

In this case, due to a very slow decarburization reaction in a vacuum, a heat-treatment time of several tens of hours is required to obtain the (100) [0vw] orientation after final annealing, and thus batch-type heat treatment, which is suitable for the long heat treatment time, is inevitable.

However, a method for producing a (100) [0vw] non-oriented electrical steel strip according to one embodiment of the present invention does not use the conventional heat treatment method based on the austenite (γ)-to-ferrite (α) phase transformation for a long time in an oxidative vacuum atmosphere, but uses a composition showing a ferrite structure in the entire temperature range of the production process as shown in Table 1 below. Also, in the method of the present invention, the content of the strong austenite stabilizing element C in the composition is limited to more than 0 wt o, but not more than 0.005 wt o, in order to easily obtain the (100) [0vw] orientation in a reducing gas atmosphere within a short time after final annealing.

Thus, in the method for producing the (100) [0vw] non-oriented electrical steel strip according to one embodiment of the present invention, the winding-rewinding method, which is used in a conventional method for producing a (111) [uvw] non-oriented electrical steel strip, can be used, and thus the steel strip can be produced in large amounts within a short time, and the production cost of the steel strip can be reduced as a result of improvement in productivity.

Meanwhile, inevitable impurity elements whose contents should be reduced to the lowest possible levels include Ti, B, Sn, Sb, Ca, Zr, Nb, V, Cu and the like.

Si: 2.0-4.0 wt %

Si is an element that increases resistivity to reduce eddy current loss (a kind of core loss). If Si is added in more than 4.0 wt %, the cold rolling property of the steel strip will be reduced, thereby leading to the fracture of the rolled steel strip. For this reason, the content of Si is preferably limited to between 2.0 wt % and 4.0 wt %, in which the composition of the slab in a production process according to one embodiment of the present invention can show a ferrite structure in the entire temperature range.

Mn: Not Less than 0.05 Wt %, but Less than 1.0 Wt %

Mn is an austenite-stabilizing element that increases resistivity to reduce eddy current loss (a kind of core loss), like Si. If Mn is added in an amount of 1 wt % or more to an electrical steel strip comprising 2-4 wt % of Si, it will increase the volume fraction of austenite in the steel strip, and thus the slab cannot show a ferrite structure throughout the entire temperature range of the production process.

For this reason, in order to obtain the non-oriented electrical steel strip having the desired (100) [0vw] orientation using the production method of the present invention, the content of Mn is preferably limited to not less than 0.05 wt %, which is the minimum content in current steel making processes, but less than 1.0 wt %, so that the slab can show a ferrite structure throughout the entire temperature range of the production process.

Al: More than 0 Wt %, but not More than 0.2 Wt %

Al is an element that is effective in increasing resistivity to reduce eddy current loss, like Si. Thus, it is added in an amount of about 0.2-1.3 wt % to a conventional (111) [uvw] non-oriented electrical steel strip.

However, an object of the present invention is to produce a (100) [0vw] non-oriented electrical steel strip, and thus if the content of Al in the composition of the present invention is more than 0.2 wt %, a surface oxide layer will be formed by Al during annealing, an H₂S reaction between S, segregated to the steel strip surface beneath the surface oxide layer, and hydrogen in a reducing atmosphere, will not easily occur due to the surface oxide layer, and thus the segregation concentration of S in the steel strip surface beneath the surface oxide layer will increase.

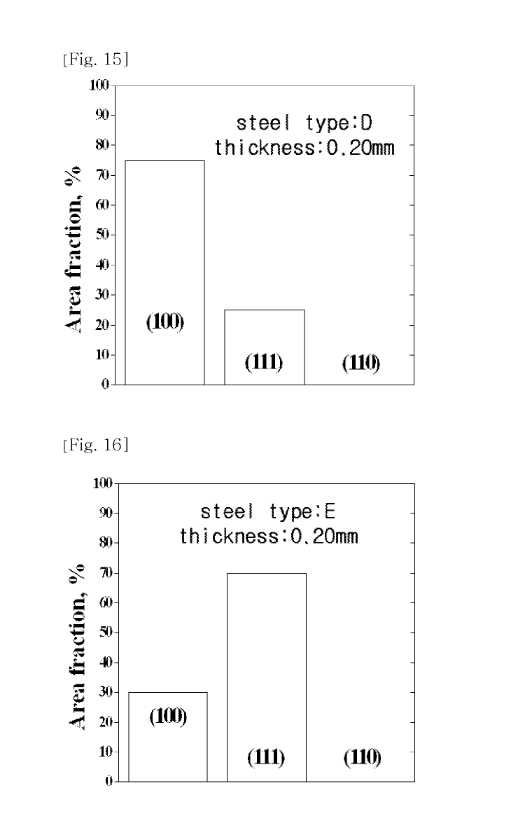

As a result, the surface energy of (111) grains rather than the surface energy of (100) grains will be minimized. Thus, as the content of Al increases, the surface-energy-induced selective growth of (111) grains is be promoted rather than the surface-energy-induced selective growth of (100) grains, so that the final crystallographic orientation changes from the (100) [0vw] orientation to the (111) [uvw] orientation, as shown in Example 10 below and FIGS. 15 and 16. For these reasons, the content of Al is preferably limited to more than 0 wt %, but not more than 0.2 wt %, in order to obtain the (100) [0vw] orientation.

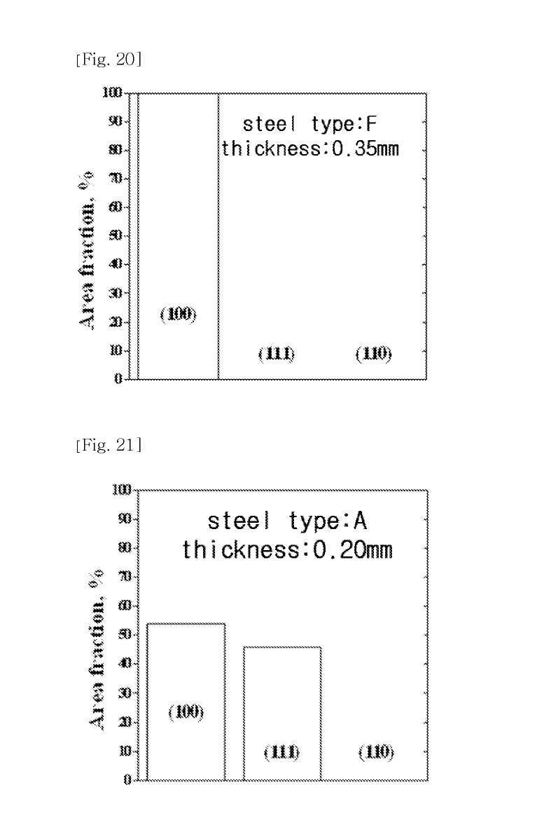

P: more than 0 wt %, but not more than 0.2 wt % P is added because it increases resistivity to thus reduce core loss. As can be seen from the results in FIG. 20 regarding Example 13 below, even when P is added in an amount of 0.1 wt %, it does not affect the obtainment of a complete (100) [0vw] orientation. However, if too much P is added, the possibility of cracking during cold rolling will be increased due to the grain boundary brittlement caused by the grain boundary segregation of P during hot rolling. For this reason, the content of P is preferably limited to more than 0 wt %, but not more than 0.2 wt %.

N: More than 0 Wt %, but not More than 0.003 Wt %

In order to prevent produced AlN from interfering with the selective growth of (100) [0vw] grains, the content of N is reduced to the lowest possible level. Preferably, the content of N is limited to more than 0 wt %, but not more than 0.003 wt %.

Hereinafter, a method for producing a (100) [0vw] non-oriented electrical steel strip having excellent magnetic properties according to one embodiment of the present invention will be described.

In a hot-rolling process, a slab is heated to a temperature of 1200° C. or above, and finishing is performed at a temperature of 900° C. or above. Thus, because there is little or no precipitation of fine AlN and MnS in the hot-rolled steel strip, grain growth in final annealing is not adversely affected. Also, in the case in which the annealing of hot-rolled steel strips having the same composition is performed, and in the case in which annealing is not performed, similar magnetic properties can be obtained.

According to one embodiment of the present invention, a hot-rolled and pickled steel strip may be cold-rolled once to a final strip thickness, or may alternatively be subjected to two cold rollings with intermediate annealing therebetween.

The solid solution temperature of 0.0001% S is 950° C., and the solid solution temperature of 0.035% S is 1370° C. Thus, the temperature of the intermediate annealing is preferably 950° C.˜1370° C. depending on the content of S, so that MnS which can be created after hot rolling is dissolved to form a solid solution.

As described above, final annealing consisting of first-stage annealing and second-stage annealing, needs to be performed in a reducing gas atmosphere containing hydrogen and/or nitrogen in order to prevent (111) grains from growing due to the surface oxidation of Al, Fe, Si and the like.

In addition, the reason why final annealing is divided into first-stage annealing and second-stage annealing is to obtain a stable (100) [0vw] orientation in the second-stage annealing. First-stage annealing and second-stage annealing are performed in a first-stage annealing furnace and a second-stage annealing furnace, respectively, and a connection passage is provided between the annealing furnaces so that continuous annealing can be performed.

In order to minimize the growth of (111) grains during first-stage annealing and maximize the growth of (100) grains at the second-stage annealing temperature, which is higher than the first-stage annealing temperature, the temperature of the first-stage annealing furnace and the time of heat treatment in the first-stage annealing furnace are 800° C.˜1100° C. and 10-600 seconds, respectively, and the temperature of the second-stage annealing furnace and the time of heat treatment in the second-stage annealing furnace are 1150° C.˜1370° C. and 10-600 seconds, respectively.

If the heat treatment time is shorter than 10 seconds, the time of atom migration will be insufficient, making it difficult to align the (100) texture, and if it is longer than 600 seconds, the (111) texture will be obtained. For this reason, the heat treatment time is preferably 10-600 seconds, as described above.

A (100) [0vw] non-oriented electrical steel strip according to one embodiment of the present invention can be continuously produced using the winding-rewinding method throughout the process ranging from hot rolling to final annealing.

Meanwhile, the surface of the produced electrical steel strip may, if necessary, be coated using a conventional coating method.

Hereinafter, examples of the present invention will be described.

Table 1 below shows the various chemical compositions of the specimens to be used in examples below, and elements other than the elements shown in Table 1 are Fe and inevitable impurities. The specimens had a strip shape, and the strip materials were cast into ingots by a vacuum-induced melting process. Each of the ingots was heated to 1200° C., and then hot-rolled to a thickness of 3 mm. Each of the hot-rolled strips was annealed at 950° C.˜1370° C. in order to dissolve MnS which could be produced during the hot rolling depending on the content of S. Alternatively, the hot-rolled strips were not annealed. Next, each strip was pickled, and then cold-rolled, thereby producing cold-rolled steel strips having a thickness of 0.10-0.70 mm. Herein, the cold-rolling reduction ratio was in the range of 77-97%.

In addition, final annealing of the cold-rolled steel strips was performed either by a one-stage annealing process at 1150° C.˜1370° C. in a reducing gas atmosphere in place of a vacuum atmosphere, or by a heat-treatment process consisting of first-stage annealing and second-stage annealing. In the case of the heat-treatment process consisting of first-stage annealing and second-stage annealing, the temperature of the first-stage annealing furnace and the time of heat treatment in the first-stage annealing furnace were 800° C.˜1100° C. and 10-600 seconds, respectively, and the temperature of the second-stage annealing furnace and the time of heat treatment in the second-stage annealing furnace were 1150° C.˜1370° C. and 10-600 seconds. To examine the crystallographic orientation of the annealed steel strips, the Etch-pit method and an optical microscope were used.

TABLE 1

| Steel | Components (wt %) | | | | | | |
|---|---|---|---|---|---|---|---|
| type | C | Si | Mn | P | S | Al | N |
| A | 0.002 | 3.3 | 0.7 | 0.003 | 0.001 | 0.0008 | 0.002 |
| B | 0.002 | 2.1 | 0.1 | 0.003 | 0.001 | 0.0007 | 0.002 |
| C | 0.002 | 3.3 | 0.7 | 0.002 | 0.007 | 0.0008 | 0.002 |
| D | 0.002 | 2.1 | 0.1 | 0.003 | 0.001 | 0.2 | 0.002 |
| E | 0.002 | 0.1 | 0.1 | 0.002 | 0.002 | 1.5 | 0.002 |
| F | 0.002 | 3.3 | 0.7 | 0.1 | 0.001 | 0.0008 | 0.002 |
| G | 0.002 | 3.3 | 0.7 | 0.002 | 0.011 | 0.0005 | 0.002 |
| H | 0.002 | 3.3 | 0.7 | 0.002 | 0.035 | 0.0005 | 0.002 |

### Example 1

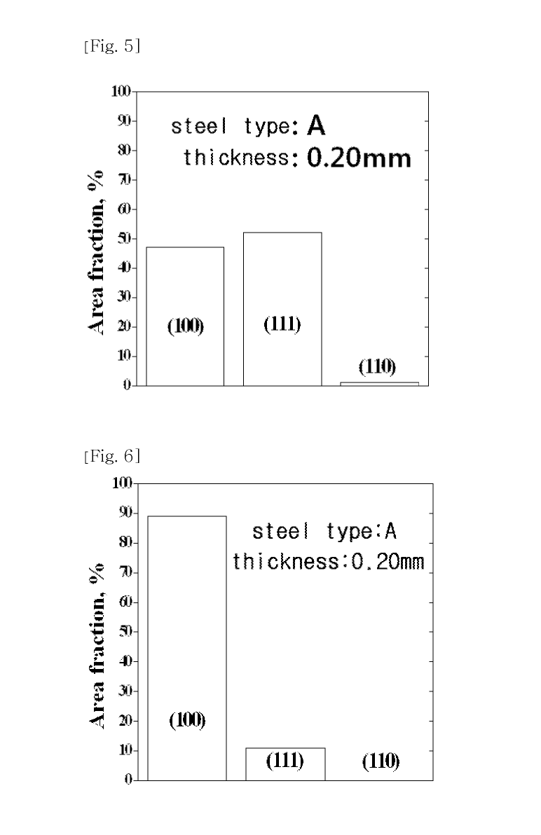

A hot-rolled strip having the composition shown in A of Table 1 was annealed at 1050° C., after which it was pickled and cold-rolled, thereby producing a cold-rolled steel strip having a thickness of 0.20 mm. The cold-rolled steel strip was finally annealed at 1,300° C. for 600 seconds without being subjected to first-stage annealing. FIG. 5 shows the results of this example, and as can be seen therein, the crystallographic orientation was not a complete (100%) (100) [0vw], but was 47% (100) [0vw] and 52% (111) [uvw].

### Example 2

A hot-rolled strip having the composition shown in A of Table 1 was annealed at 1050° C., after which it was pickled and cold-rolled, thereby producing a cold-rolled steel strip having a thickness of 0.20 mm. In a final annealing process, the cold-rolled steel strip was subjected to first-stage annealing at 850° C. for 540 seconds, and then subjected to second-stage annealing at 1300° C. for 15 seconds. FIG. 6 shows the results of this example, and as can be seen therein, a non-oriented electrical steel strip structure consisting of about 89% (100) [0vw] and 11% (111) [uvw] was obtained.

### Example 3

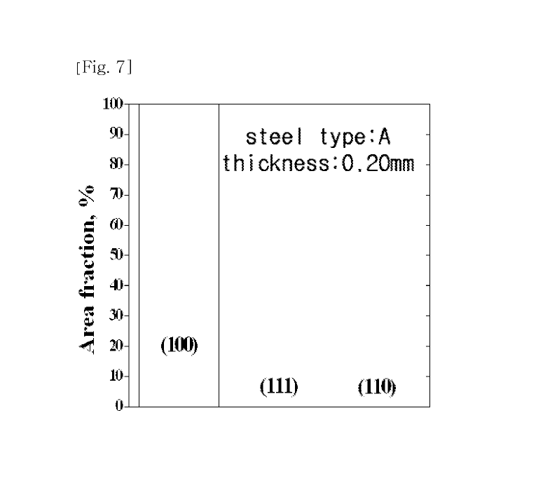

A hot-rolled strip having the composition shown in A of Table 1 was annealed at 1050° C., after which it was pickled and cold-rolled, thereby producing a cold-rolled steel strip having a thickness of 0.20 mm. In a final annealing process, the cold-rolled steel strip was subjected to first-stage annealing at 850° C. for 540 seconds, and then subjected to second-stage annealing at 1300° C. for 60 seconds. FIG. 7 shows the results of this example, and as can be seen therein, a complete (100%) (100) [0vw] non-oriented electrical steel strip structure was obtained. FIG. 8 shows the Etch-pit structure of the produced steel strip. As can be seen in FIG. 8, the steel strip shows an Etch-pit form in which the main orientation of the complete (100%) (100) [0vw] orientation is (100) [012].

### Example 4

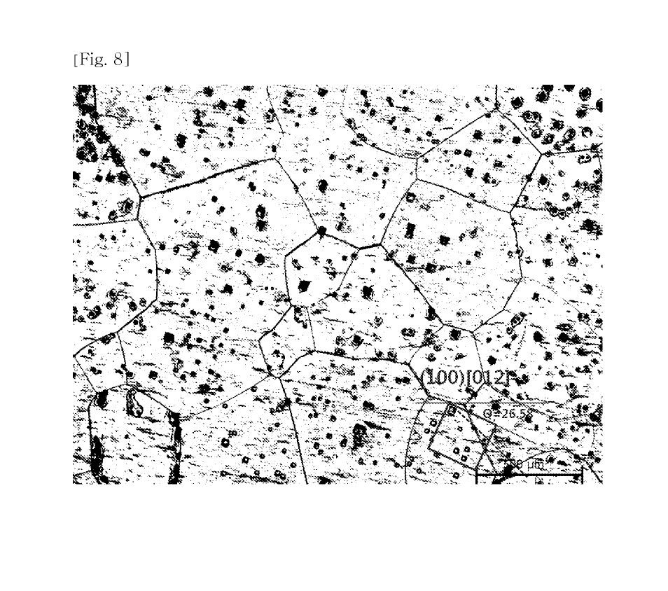

A hot-rolled strip having the composition shown in A of Table 1 was annealed at 1050° C., after which it was pickled and cold-rolled, thereby producing a cold-rolled steel strip having a thickness of 0.20 mm. In a final annealing process, the cold-rolled steel strip was subjected to first-stage annealing at 850° C. for 180 seconds, and then subjected to second-stage annealing at 1150° C. for 600 seconds. FIG. 9 shows the results of this example, and as can be seen therein, a complete (100%) (100) [0vw] non-oriented electrical steel strip having a main orientation of (100) [012] was obtained.

### Example 5

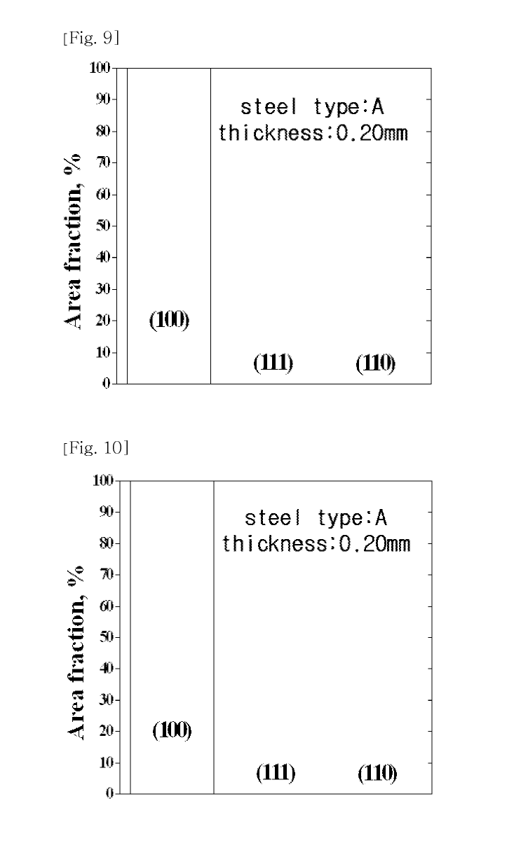

A hot-rolled strip having the composition shown in A of Table 1 was not annealed, and was pickled and cold-rolled, thereby producing a cold-rolled steel strip having a thickness of 0.20 mm. In a final annealing process, the cold-rolled steel strip was subjected to first-stage annealing at 850° C. for 540 seconds, and then subjected to second-stage annealing at 1300° C. for 120 seconds. FIG. 10 shows the results of this example, and as can be seen therein, a complete (100%) (100) [0vw] non-oriented electrical steel strip having a main orientation of (100) [012] was obtained.

### Example 6

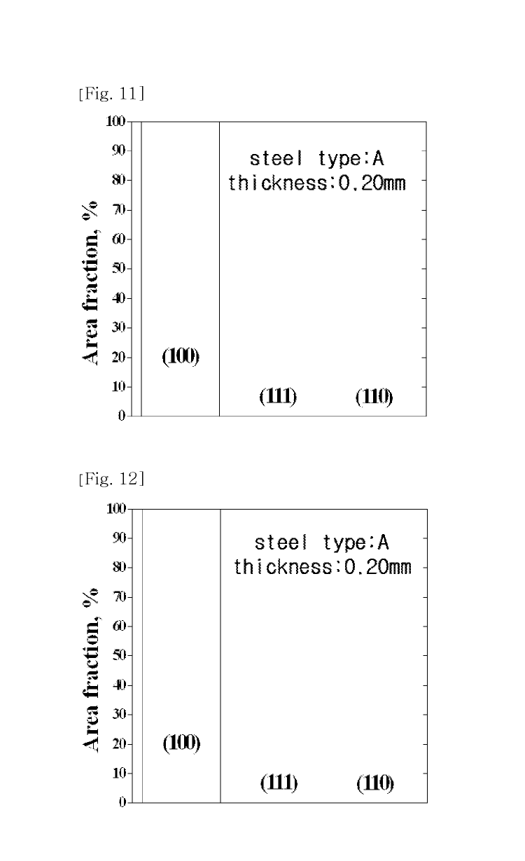

A hot-rolled strip having the composition shown in A of Table 1 was not annealed, and was pickled and cold-rolled, thereby producing a cold-rolled steel strip having a thickness of 0.20 mm. In a final annealing process, the cold-rolled steel strip was subjected to first-stage annealing at 1100° C. for 10 seconds, and then subjected to second-stage annealing at 1150° C. for 600 seconds. FIG. 11 shows the results of this example, and as can be seen therein, a complete (100%) (100) [0vw] non-oriented electrical steel strip having a main orientation of (100) [012] was obtained.

### Example 7

A hot-rolled strip having the composition shown in A of Table 1 was not annealed, and was pickled and cold-rolled, thereby producing a cold-rolled steel strip having a thickness of 0.20 mm. In a final annealing process, the cold-rolled steel strip was subjected to first-stage annealing at 800° C. for 600 seconds, and then subjected to second-stage annealing at 1370° C. for 10 seconds. FIG. 12 shows the results of this example, and as can be seen therein, a complete (100%) (100) [0vw] non-oriented electrical steel strip having a main orientation of (100) [012] was obtained.

### Example 8

A hot-rolled strip having the composition shown in B of Table 1 was not annealed, and was pickled and cold-rolled, thereby producing a cold-rolled steel strip having a thickness of 0.20 mm. In a final annealing process, the cold-rolled steel strip was subjected to first-stage annealing at 850° C. for 540 seconds, and then subjected to second-stage annealing at 1300° C. for 120 seconds. FIG. 13 shows the results of this example, and as can be seen therein, a complete (100%) (100) [0vw] non-oriented electrical steel strip having a main orientation of (100) [012] was obtained.

### Example 9

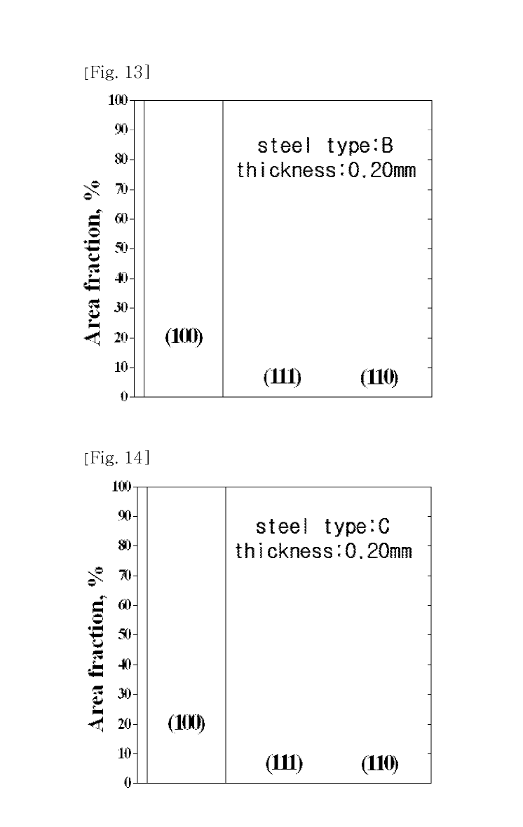

A hot-rolled strip having the composition shown in C of Table 1 was annealed at 1230° C., after which it was pickled and cold-rolled, thereby producing a cold-rolled steel strip having a thickness of 0.20 mm. In a final annealing process, the cold-rolled steel strip was subjected to first-stage annealing at 960° C. for 120 seconds, and then subjected to second-stage annealing at 1300° C. for 120 seconds. FIG. 14 shows the results of this example, and as can be seen therein, a complete (100%) (100) [0vw] non-oriented electrical steel strip having a main orientation of (100) [012] was obtained.

### Example 10

A hot-rolled strip having the composition shown in each of D and E of Table 1 was not annealed, and was pickled and cold-rolled, thereby producing cold-rolled steel strips having a thickness of 0.20 mm. In a final annealing process, each of the cold-rolled steel strips was subjected to first-stage annealing at 850° C. for 540 seconds, and then subjected to second-stage annealing at 1300° C. for 120 seconds. FIGS. 15 and 16 show the results of this example, and as can be seen therein, as Al was added, the (111) [uvw] orientation remained after the final annealing, and as the content of Al increased, the crystallographic orientation changed from 100% (100) [0vw] to 75% (100) [0vw]+25% (111) [uvw] and 30% (100) [0vw]+70% (111) [uvw].

### Example 11

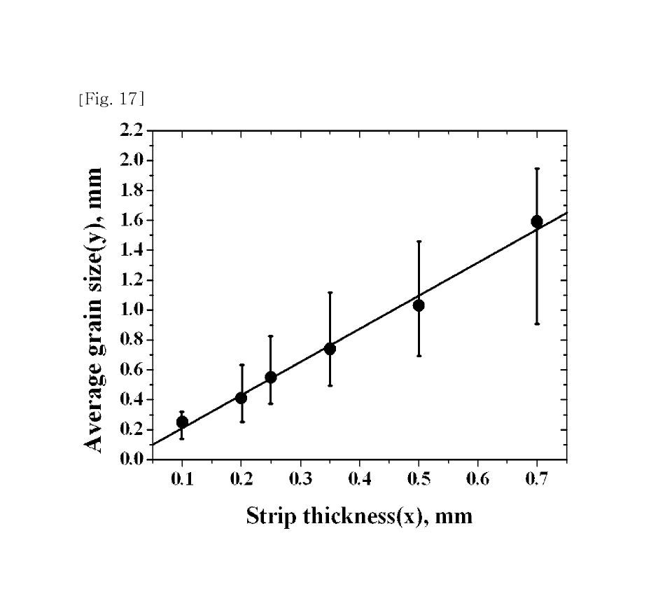

A hot-rolled strip having the composition shown in A of Table 1 was not annealed, and was pickled and cold-rolled, thereby producing a cold-rolled steel strip having a thickness of 0.10-0.70 mm. In a final annealing process, the cold-rolled steel strip was subjected to first-stage annealing at 960° C. for 120 seconds, and then subjected to second-stage annealing at 1300° C. for 120 seconds. A complete (100%) (100) [0vw] orientation could be obtained regardless of the thickness of the steel strip. FIG. 17 graphically shows the relationship between the average grain size (y, mm) and strip thickness (x, mm) of the steel strip.

As can be seen in FIG. 17, the average grain size (y, mm) of the annealed strip surface, which shows a 100% (100) [0vw] orientation, and the strip thickness (x, mm) showed a linear relationship of y=2.2x+0.1, and when the content of S was less than 0.007 wt %, a relationship of y=2.2x+0.1 was satisfied.

### Example 12

A hot-rolled strip having the composition shown in A of Table 1 was not annealed, and was pickled and cold-rolled, thereby producing cold-rolled steel strips having thicknesses of 0.25 mm and 0.35 mm. In a final annealing process, each of the cold-rolled steel strips was subjected to first-stage annealing at 800° C. for 120 seconds, and then subjected to second-stage annealing at 1300° C. for 60 seconds.

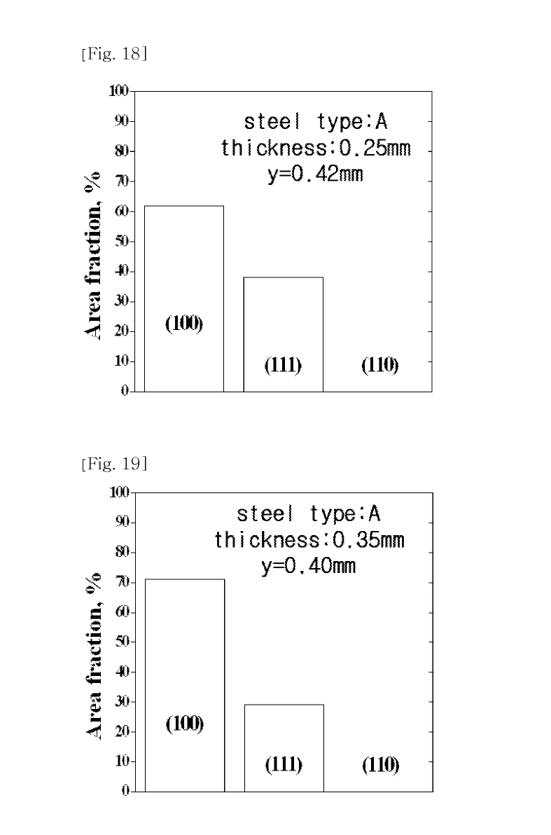

FIGS. 18 and 19 show the orientation distributions and average grain sizes (y) of the steel strips. As can be seen therein, a relationship of y<2.2x+0.1 was shown between the average grain size (y) of the annealed strip surface and the strip thickness (x), and the crystallographic orientation was not a 100% (100) [0vw], but showed a significant fraction of (111) [uvw] regardless of the thickness of the steel strip.

This is because the growth of (111) grains in the initial stage of the second-stage annealing (at 1300° C. for 60 seconds) was active due to improper first-stage annealing, and the (111) grains remained after completion of second-stage annealing, even though (100) grains grew for the remaining time while encroaching upon the (111) grains.

Thus, in order to obtain a complete (100%) (100) [0vw] orientation after first-stage and second-stage annealing, heat treatment should be performed so that the average grain size (y) of the annealed strip surface and the strip thickness (x) show a relationship of y≧2.2x+0.1, if the content of S is less than 0.007 wt %.

When summarizing the results of Example 12, it can be seen that, when the grain size (y) was equal to or greater than the thickness (x) of the annealed strip, a 50% or more (100) [0vw] orientation could be obtained.

### Example 13

A hot-rolled strip having the composition shown in F of Table 1 was not annealed, and was pickled and cold-rolled, thereby producing a cold-rolled steel strip having a thickness of 0.35 mm. In a final annealing process, the cold-rolled steel strip was subjected to first-stage annealing at 850° C. for 540 seconds, and then subjected to second-stage annealing at 1300° C. for 120 seconds. FIG. 20 shows the results of this example, and as can be seen therein, a complete (100%) (100) [0vw] orientation structure was obtained.

### Example 14

A hot-rolled strip having the composition shown in A of Table 1 was not annealed, and was pickled and cold-rolled, thereby producing a cold-rolled steel strip having a thickness of 0.20 mm. The cold-rolled steel strip was finally annealed at 1150° C. for 240 seconds without being subjected to first-stage annealing. FIG. 21 shows the results of this example, and as can be seen therein, the crystallographic orientation was not (100) [0vw], but was 54% (100) [0vw] and 46% (111) [uvw].

### Example 15

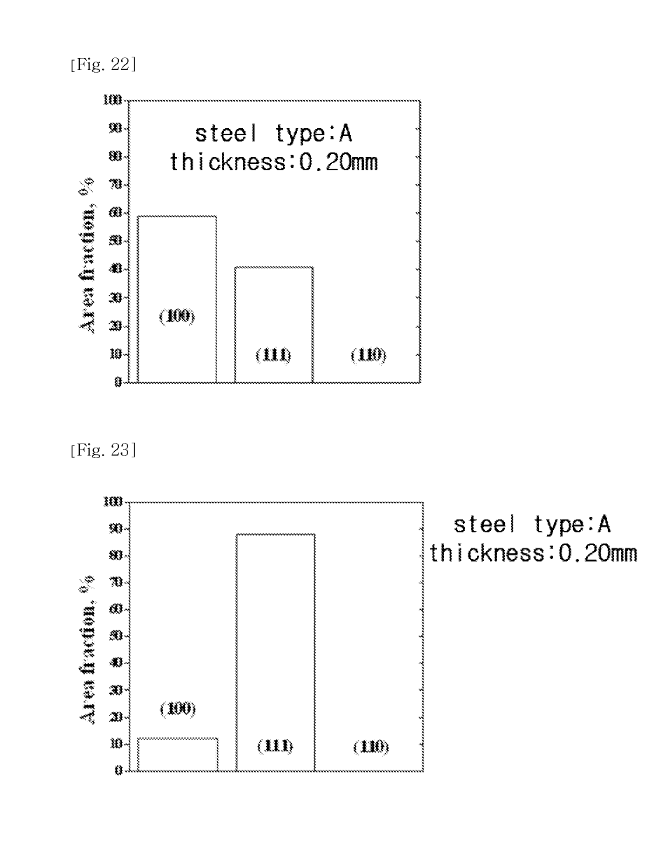

A hot-rolled strip having the composition shown in A of Table 1 was not annealed, and was pickled and cold-rolled, thereby producing a cold-rolled steel strip having a thickness of 0.20 mm. The cold-rolled steel strip was finally annealed at 1370° C. for 400 seconds without being subjected to first-stage annealing. FIG. 22 shows the results of this example, and as can be seen therein, the crystallographic orientation was not (100) [0vw], but was 59% (100) [0vw] and 41% (111) [uvw].

### Example 16

A hot-rolled strip having the composition shown in A of Table 1 was not annealed, and was pickled and cold-rolled, thereby producing a cold-rolled steel strip having a thickness of 0.20 mm. In a final annealing process, the cold-rolled steel strip was subjected to first-stage annealing at 750° C. for 1000 seconds, and was then subjected to second-stage annealing at 1130° C. for 8 seconds. FIG. 23 shows the results of this example, and as can be seen therein, a non-oriented electrical steel strip structure having 85% or more (111) [uvw] as a main orientation was obtained.

### Example 17

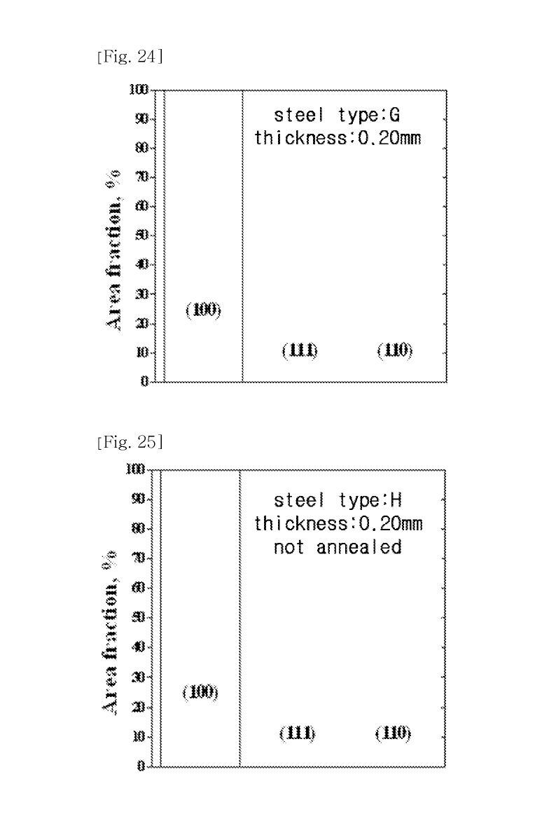

A hot-rolled strip having the composition shown in G of Table 1 was annealed at 1330° C., pickled and cold-rolled, thereby producing a cold-rolled steel strip having a thickness of 0.20 mm. In a final annealing process, the cold-rolled steel strip was subjected to first-stage annealing at 1020° C. for 30 seconds, and was then subjected to second-stage annealing at 1300° C. for 240 seconds. FIG. 24 shows the results of this example, and as can be seen therein, a 100% (100) [0vw] non-oriented electrical steel strip structure was obtained.

### Example 18

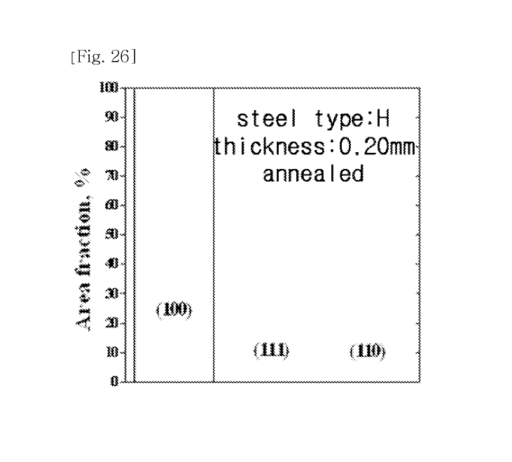

A hot-rolled strip having the composition shown in H of Table 1 was annealed at 1370° C., or was not annealed. Then, the steel strip was pickled and cold-rolled, thereby producing a cold-rolled steel strip having a thickness of 0.20 mm. In a final annealing process, the cold-rolled steel strip was subjected to first-stage annealing at 1020° C. for 30 seconds, and was then subjected to second-stage annealing at 1300° C. for 120 seconds. FIGS. 25 and 26 show the results of this example, and as can be seen therein, a 100% (100) [0vw] non-oriented electrical steel strip structure was obtained regardless of whether or not annealing was performed.

### Example 19

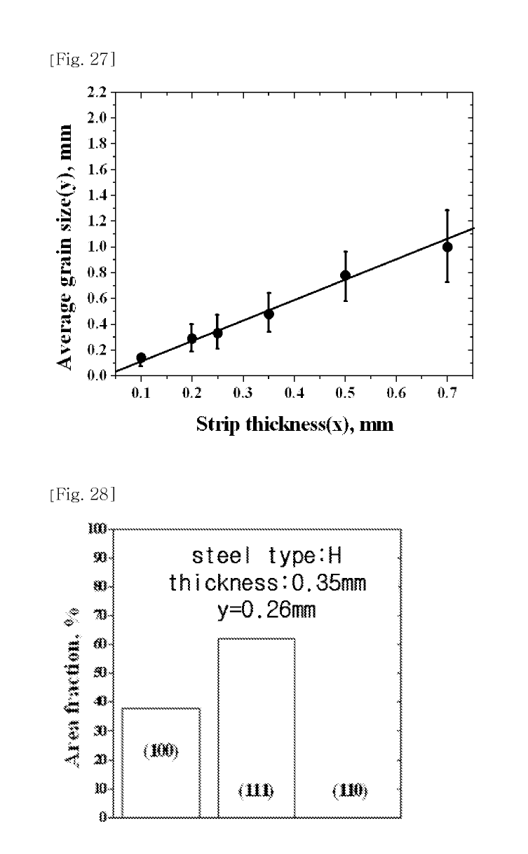

A hot-rolled strip having the composition shown in H of Table 1 was not annealed, and was pickled and cold-rolled, thereby producing cold-rolled steel strips having a thickness of 0.10-0.70 mm. In a final annealing process, each of the cold-rolled steel strips was subjected to first-stage annealing at 1020° C. for 30 seconds, and was then subjected to second-stage annealing at 1300° C. for 90 seconds. A complete (100%) (100) [0vw] orientation could be obtained regardless of the thickness of the steel strip, and FIG. 27 graphically shows the relationship between the average grain size (y, mm) of the annealed strip surface and the strip thickness (x, mm).

As can be seen in FIG. 27, the average grain size (y, mm) of the annealed strip surface, which show a complete (100%) (100) [0vw] orientation, and the strip thickness (x, mm) showed a linear relationship of y=1.48x+0.04, and a relationship of y=1.48x+0.04 was satisfied when the content of S was 0.007 wt % or more.

### Example 20

A hot-rolled strip having the composition shown in H of Table 1 was not annealed, and was pickled and cold-rolled, thereby producing a cold-rolled steel strip having a thickness of 0.35 mm. In a final annealing process, the cold-rolled steel strip was subjected to first-stage annealing at 1020° C. for 5 seconds, and was then subjected to second-stage annealing at 1300° C. for 10 seconds. FIG. 28 shows the orientation distribution and average grain size (y) of the steel strip. As can be seen therein, a relationship of y<1.48x+0.04 was shown between the average grain size (y) of the annealed strip surface and the strip thickness (x), and the crystallographic orientation was not a 100% (100) [0vw], but showed a significant fraction of (111) [uvw]. This is because the growth of (111) grains in the initial stage of the second-stage annealing (at 1300° C. for 10 seconds) was active due to improper first-stage annealing, and the (111) grains remained after the completion of second-stage annealing, even though (100) grains grew for the remaining time while encroaching upon the (111) grains.

Thus, in order to obtain a complete (100%) (100) [0vw] orientation after first-stage and second-stage annealing, heat treatment should be performed so that the average grain size (y) of the annealed strip surface and the strip thickness (x) show a relationship of y≧1.48x+0.04, if the content of S is 0.007 wt % or more.

### INDUSTRIAL APPLICABILITY

In a conventional method for producing a (100) [0vw] non-oriented electrical steel strip, a steel strip comprising large amounts of C and Mn is heat-treated in vacuum for a long time to achieve the austenite (γ)-to-ferrite (α) phase transformation. In comparison with the conventional method, in the method for producing the (100) [0vw] non-oriented electrical steel strip having excellent magnetic properties according to one embodiment of the present invention, a steel strip showing a ferrite structure in the entire heat-treatment temperature range is heat-treated in a reducing gas atmosphere in place of a vacuum atmosphere, and thus the (100) [0vw] orientation is formed in an easy and cost-effective manner within a short time.

Thus, according to the present invention, a non-oriented electrical steel strip can be produced using the winding-rewinding method. In addition, the steel strip can be produced at greater productivity, and the production cost can be reduced.

1. A method for producing a (100) [0vw] non-oriented electrical steel strip having excellent magnetic properties, the method comprising:
hot-rolling a slab having a composition comprising, by wt o, C: more than 0%, but not more than 0.005%, Si: 2-4%, Mn: not less than 0.05%, but less than 1.0%, S: 0.0001-0.035%, Al: more than 0%, but not more than 0.20%, P: more than 0%, but not more than 0.2%, N: more than 0%, but not more than 0.003%, the balance being Fe and inevitable impurities;
pickling the hot-rolled steel strip;
cold-rolling the pickled steel strip;
subjecting the cold-rolled steel strip to first-stage annealing in a first-stage annealing furnace at temperature of 800° C.˜1100° C.; and
subjecting the cold-rolled steel strip to second-stage annealing in a second-stage annealing furnace at a temperature of 1150° C.˜1370° C., which is higher than the temperature of the first-stage annealing furnace, wherein the average grain size (y) and strip thickness (x) of the finally annealed steel strip satisfy the following relationship: y≧2.2x+0.1 (unit: mm) if the content of S is less than 0.007 wt %, and y≧1.48x+0.04 (unit: mm) if the content of S is 0.007 wt % or more.

2. The method of claim 1, wherein the time of heat treatment in the first-stage annealing furnace is 10-600 seconds, and the time of heat treatment in the second-stage annealing furnace is 10-600 seconds.

3. The method of claim 1, wherein the slab is reheated and hot-rolled, after which it is subjected to intermediate annealing at a temperature of 950° C.˜1370° C. in order to dissolve MnS, which is able to be produced during the hot rolling, to form a solid solution, or the intermediate annealing is not performed, and then the rolled strip is pickled and cold-rolled.

4. The method of claim 1, wherein the content of S in the composition is more than 0.008%, but not more than 0.035%.

5. The method of claim 1, wherein the slab structure during the hot rolling and the annealed strip structure at the annealing temperature are a ferrite phase structure.

6. The method of claim 1, wherein the first-stage and second-stage annealing furnaces employ a reducing gas atmosphere in order to prevent (111) grains from growing due to surface oxidation during the annealing of the cold-rolled steel strip.

7. A (100) [0vw] non-oriented electrical steel strip having excellent magnetic properties, wherein the electrical steel strip has a composition comprising, by wt %, C: more than 0%, but not more than 0.005%, Si: 2-4%, Mn: not less than 0.05%, but less than 1.0%, S: 0.0001-0.035%, Al: more than 0%, but not more than 0.20%, P: more than 0%, but not more than 0.2%, N: more than 0%, but not more than 0.003%, the balance being Fe and inevitable impurities, and the average grain size of the surface of the steel strip is equal to or greater than the thickness of the steel strip.

8. The (100) [0vw] non-oriented electrical steel strip of claim 7, wherein the average grain size (y) of the strip surface and the strip thickness (x) satisfy the following relationship: y≧2.2x+0.1 (unit: mm) if the content of S is less than 0.007 wt %.

9. The (100) [0vw] non-oriented electrical steel strip of claim 7, wherein the average grain size (y) of the strip surface and the strip thickness (x) satisfy the following relationship: y≧1.48x+0.04 (unit: mm) if the content of S is 0.007 wt % or more.

10. The (100) [0vw] non-oriented electrical steel strip of claim 7, wherein the steel strip is subjected to first-stage annealing in a first-stage annealing furnace at a temperature of 800° C.˜1100° C., and subjected to second-stage annealing in a second-stage annealing furnace at a temperature of 1150° C.˜1370° C., which is higher than the temperature of the first-stage annealing furnace.

11. The (100) [0vw] non-oriented electrical steel strip of claim 10, wherein the time of heat treatment in the first-stage annealing furnace is 10-600 seconds, and the time of heat treatment in the second-stage annealing furnace is 10-600 seconds.

12. The (100) [0vw] non-oriented electrical steel strip of claim 7, wherein the content of S in the composition is more than 0.008%, but not more than 0.035%.

13. The (100) [0vw] non-oriented electrical steel strip of claim 8, wherein the average grain size (y) of the surface and the strip thickness (x) satisfy the following relationship: y≧1.48x+0.04 (unit: mm) if the content of S is 0.007 wt % or more.
